(19) United States
(12) Patent Application Publication
(10) Pub. No.: US 2017/0011735 A1
(43) Pub. Date: Jan. 12, 2017

(54) SPEECH RECOGNITION SYSTEM AND METHOD

(71) Applicant: ELECTRONICS AND TELECOMMUNICATIONS RESEARCH INSTITUTE, Daejeon (KR)

(72) Inventors: Dong Hyun KIM, Seoul (KR); Min Kyu LEE, Daejeon (KR)

(21) Appl. No.: 15/187,948

(22) Filed: Jun. 21, 2016

(30) Foreign Application Priority Data
Jul. 10, 2015 (KR) 10-2015-0098383
May 25, 2016 (KR) 10-2016-0064193

(51) Int. Cl. G10L 15/00; G10L 15/183; G10L 15/02

(52) U.S. Cl. CPC G10L 15/005; G10L 15/02; G10L 15/183; G10L 2015/025

(57) ABSTRACT

A system and a method of speech recognition which enable a spoken language to be automatically identified while recognizing speech of a person who vocalize to effectively process multilingual speech recognition without a separate process for user registration or recognized language setting such as use of a button for allowing a user to manually select a language to be vocalized and support speech recognition of each language to be automatically performed even though persons who speak different languages vocalize by using one terminal to increase convenience of the user.

### CROSS-REFERENCE TO RELATED APPLICATIONS

This application claims priority to and the benefit of Korean Patent Application No. 10-2015-0098383 filed in the Korean Intellectual Property Office on Jul. 10, 2015, and Korean Patent Application No. 10-2016-0064193 filed in the Korean Intellectual Property Office on May 25, 2016, the entire contents of which are incorporated herein by reference.

### BACKGROUND OF THE INVENTION

1. Field of the Invention

The present invention relates to a system and a method of speech recognition, and particularly, to a system and a method of speech recognition which simultaneously perform language identification and speech recognition in order to effectively process multilingual speech recognition.

2. Description of Related Art

An offline or online speech recognition system in the related art is applied for multilingual speech recognition in a user terminal and in general, speech recognizers of different languages are operated according to a situation by separately providing a speech recognition button for each language. Furthermore, in the speech recognition system in the related art, a method that automatically finds a used language through text contents or device information possessed by a user may be used. In order to find the used language, the user needs to be registered in an online server in advance and a method is used, which predetermines a vocalized language of the user depending on the user terminal. That is, in this method, only one person needs to use one terminal and it is difficult to perform automatic speech recognition by one terminal in a multilingual conference which can speech-recognize vocalization of various speakers, and the like.

In another speech recognition system in the related art language identification may be performed by a phone recognition method by using a multilingual common phone. This method as a method that makes a generation pattern of a phone into a statistical language mode to be used for the language identification performs the language identification in real time by using speech data, in yet another speech recognition system in the related art, a method that identifies the language by using a deep neural network (DNN) frequently used in an acoustic model may be proposed and in this method, the language is identified by a method that designates a final output node by each language in generation of a DNN structure. However, in all of the examples, a dedicated recognizer is provided, which performs only the language identification by using acoustic data as primary information, but this method is inconvenient in that a language identification recognizer which plays a different role from a basic speech recognizer needs to be separately provided.

### SUMMARY OF THE INVENTION

The present invention has been made in an effort to provide a system and a method of speech recognition which enable a spoken language to be automatically identified while speech recognition of a person who vocalizes to effectively process multilingual speech recognition without a separate process for user registration or recognized language setting such as use of a button for allowing a user to manually select a language to be vocalized and support speech recognition of each language to be automatically performed even though persons who speak different languages vocalize by using one terminal to increase convenience of the user.

In the present invention, the speech recognition and the language identification are simultaneously performed without causing a work time deviation in which a language identifier is performed by the above work in order to actuate a speech recognizer according to a language of a user who vocalizes in the related art so as to support the speech recognition and the language identification only by vocalization without the need of registering user information or depending on terminal information to be convenient to perform multilingual speech recognition. This is a method that rapidly stops a recognizer having a lower score by using a language identification score generated while processing the speech recognition by simultaneously actuating speech recognizers of multiple languages and shows a result of a high score recognizer to show a speech recognition result of the corresponding language.

In the present invention, three types of methods are proposed as a process of performing the language identification while performing the speech recognition. A first method is a method that has a parallel speech recognition configuration which can use the speech recognizer for each language in the related art and identifies the language by observing the language identification score every frame or multiple frames. A second method is a method that calculates the acoustic model score by sharing some or all of acoustic models in order to reduce calculation cost and identifies the language by measuring the language identification score every frame or every multiple frames by searching the language networks of the respective languages in parallel. A third method as a method in which calculation of the acoustic score and search of the language network are performed in one integrated network, is a method which shares all acoustic models and performs searching by combining the respective language networks into one network. The present invention has been made in an effort to provide a system and a method of speech recognition which simultaneously perform the speech recognition and the language identification.

The technical objects of the present invention are not limited to the aforementioned technical objects, and other technical objects, which are not mentioned above, will be apparently appreciated to a person having ordinary skill in the art from the following description.

An exemplary embodiment of the present invention provides a system of speech recognition for simultaneously performing language identification and speech recognition, including: a speech processing unit analyzing a speech signal to extract feature data; and a language identification speech recognition unit performing language identification and speech recognition by using the feature data and feeding back identified language information to the speech processing unit, wherein the speech processing unit outputs a result of the speech recognition in the language identification speech recognition unit according to the fed-back identified language information.

The language identification speech recognition unit may identify a language for the speech signal through analysis of likelihood with respect to the feature data by referring to an acoustic model and a language model.

The language identification speech recognition unit may include a plurality of language decoders each performing the speech recognition for the feature data in parallel and calculating a language identification score through the analysis of the likelihood every one or more speech signal frames based on the feature data by referring to the acoustic model and the language model of a corresponding language, and a language decision module deciding as the identified language a language corresponding to a selected target language decoder according to a decision rule by referring to the language identification scores accumulated while being received from the plurality of language decoders to output the identified language information.

The language decision module may sequentially transmit a decoding end command to language decoders having a low score based on the accumulated language identification scores to end operations of the language decoders, and as a result, the speech processing unit may output the result of the speech recognition in the target language decoder which finally remains.

The language identification score may be configured by a value acquired by aggregating an acoustic mode score and a language model score or an inverse number to the number of tokens for similar language candidates which are generated while searching a network, or a combination thereof.

The decision rule may include a scheme that sequentially ends language decoders which output a corresponding language identification score different from the highest accumulated language identification score value by a threshold or more per frame or a scheme that sequentially ends the language decoders which output the corresponding language identification scores different from the highest accumulated language identification score value by the corresponding threshold or more per frame by applying the threshold which varies with time.

The language identification speech recognition unit may include an acoustic model sharing unit calculating the acoustic model score through the analysis of the likelihood every one or more speech signal frames based on the feature data by sharing some of the acoustic models of the respective language among the multiple languages or all acoustic models of predetermined multiple languages, a plurality of language network decoders each performing the speech recognition of the feature data by sharing the acoustic model scores in parallel and calculating the language identification score acquired by aggregating the shared acoustic model scores and the language model scores calculated based on the feature data by referring to the language model, and a language decision module deciding as the identified language a language corresponding to a selected target language decoder according to a decision rule by referring to the language identification scores accumulated while being received from the plurality of language network decoders to output the identified language information.

The language decision module may sequentially transmit a decoding end command to language network decoders having a low score based on the accumulated language identification scores to end operations of the language network decoders, and as a result, the speech processing unit may output the result of the speech recognition in the target language decoder which finally remains.

The language identification speech recognition unit may include an acoustic model sharing unit calculating the acoustic model score through the analysis of the likelihood every one or more speech signal frames based on the feature data by sharing all of the acoustic models of the predetermined multiple languages and using the multilingual common phones and phones of individual languages together, and a combination network decoder performing the speech recognition of the feature data by using an integrated language network in which the language is not distinguished by integrating the language networks of the plurality of individual languages into one, calculating the language identification score acquired by aggregating the shared acoustic model score and the language model score calculated based on the feature data by referring to the language model and outputting a character string decided as a highest score based on the language identification score.

The speech processing unit may output the decided character string which is a result of the speech recognition in the combination network decoder through a predetermined output interface.

Another exemplary embodiment of the present invention provides a method of speech recognition for simultaneously performing language identification and speech recognition, including: analyzing a speech signal to extract feature data; performing language identification and speech recognition by using the feature data and outputting identified language information; and outputting a result of the speech recognition through the predetermined output interface according to identified language information. In the outputting of the identified language information, a language for the speech signal may be identified through analysis of likelihood with respect to the feature data by referring to an acoustic model and a language model.

The outputting of the identified language information may include performing, by each of a plurality of language decoders, the speech recognition for the feature data in parallel and calculating a language identification score through the analysis of the likelihood every one or more speech signal frames based on the feature data by referring to the acoustic model and the language model of a corresponding language, and deciding, by a language decision module, as the identified language a language corresponding to a selected target language decoder according to a decision rule by referring to the language identification scores accumulated while being received from the plurality of language decoders to output the identified language information.

In the outputting of the identified language information, a decoding end command may be sequentially transmitted to language decoders having a low score based on the accumulated language identification scores to end operations of the language decoders, and as a result, the result of the speech recognition may be output in the target language decoder which finally remains.

The language identification score may be configured by a value acquired by aggregating an acoustic model score and a language model score or an inverse number to the number of tokens for similar language candidates which are generated while searching a network, or a combination thereof.

The decision rule may include a scheme that sequentially ends language decoders which output a corresponding language identification score different from the highest accumulated language identification score value by a threshold or more per frame or a scheme that sequentially ends the language decoders which output the corresponding language identification scores different from the highest accumulated language identification score value by the corresponding threshold or more per frame by applying the threshold which varies with time.

The outputting of the identified language information may include calculating the acoustic model score through the analysis of the likelihood every one or more speech signal frames based on the feature data by sharing some of the acoustic models of the respective language among the multiple languages or all acoustic models of predetermined multiple languages, performing, by each of a plurality of language network decoders, the speech recognition of the feature data by sharing the acoustic model scores in parallel and calculating the language identification score acquired by aggregating the shared acoustic model scores and the language model scores calculated based on the feature data by referring to the language model, and deciding as the identified language a language corresponding to a selected target language decoder according to a decision rule by referring to the language identification scores accumulated while being received from the plurality of language network decoders to output the identified language information.

In the outputting of the identified language information, a decoding end command may be sequentially transmitted to language network decoders having a low score based on the accumulated language identification scores to end operations of the language network decoders, and as a result, the result of the speech recognition may be output in the target language decoder which finally remains.

The outputting of the identified language information may include calculating the acoustic model score through the analysis of the likelihood every one or more speech signal frames based on the feature data by sharing all of the acoustic models of the predetermined multiple languages and using the multilingual common phones and distinguishing phones of individual languages together, and performing, by a combination network decoder integrating language networks of the plurality of individual languages into one, the speech recognition of the feature data by using an integrated language network in which the language is not distinguished, calculating the language identification score acquired by aggregating the shared acoustic model score and the language model score calculated based on the feature data by referring to the language model and outputting a character string decided as a highest score based on the language identification score.

The method may further include outputting the decided character string which is a result of the speech recognition in the combination network decoder through a predetermined output interface.

According to exemplary embodiments of the present invention, in the system and the method of speech recognition, a speech language can be automatically identified during speech recognition of a person who vocalizes to effectively process multilingual speech recognition without a separate process for user registration or recognized language setting such as use of a button for selecting a language to be manually vocalized to the user. In the existing method, the language is decided by a method that records a used language in registration contents of the user in the terminal of the user in advance, but since language identification starts while the speech is transferred, the present invention is not dependent on the user terminal without the need of an advance work.

In the system and the method of speech recognition according to the present invention, convenience of the user may be increased by supporting automatic multilingual speech recognition so as to automatically perform speech recognition of each language even though persons of different languages vocalize by using one terminal. The present invention may be applied so as to record contents of a conference of persons having a plurality of different languages, such as a multilingual conference.

In the system and the method of speech recognition according to the present invention, since the language is discriminated based on the score measured while performing the speech recognition with respect to the speech which is vocalized in real time, the speech recognition result may be rapidly received without performing the language identification dedicated recognizer in advance.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a conceptual view of a speech recognition system according to an exemplary embodiment of the present invention, which simultaneously performs language identification and speech recognition by using input speech.

FIG. 2A illustrates a first detailed example of a language identification speech recognition unit of FIG. 1, which is used for simultaneously performing parallel speech recognition and language decision by sending the input speech to each language decoder.

FIG. 2B is a flowchart for describing an operation of the speech recognition system of FIG. 2A.

FIG. 3A illustrates a second detailed example of the language identification speech recognition unit of FIG. 1 for calculating language identification and speech recognition for input speech separately in an acoustic model sharing unit and a language network decoder.

FIG. 3B is a flowchart for describing an operation of the speech recognition system of FIG. 3A.

FIG. 4A illustrates a third derailed example of the language identification speech recognition unit of FIG. 1 for calculating language identification and speech recognition for input speech separately in an acoustic model sharing unit and a combination network unit.

FIG. 4B is a flowchart for describing an operation of the speech recognition system of FIG. 4A.

FIG. 5 illustrates a detailed example of a combination network decoder of FIG. 4A.

FIG. 6 is a diagram for describing an example of an implementation method of a speech recognition system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals refer to components of each drawing, it is noted that although the same components are illustrated in different drawings, the same components are referred to by the same reference numerals as possible. In describing the exemplary embodiments of the present invention, when it is determined that the detailed description of the known configuration or function related to the present invention may disturb appreciation for the exemplary embodiments of the present invention, the detailed description thereof will be omitted.

Terms such as first, second, A, B, (a), (b), and the like may be used in describing the components of the exemplary embodiments according to the present invention. The terms are only used to distinguish a constituent element from another constituent element, but nature or an order of the constituent element is not limited by the terms. Further, if it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art, and are not interpreted as an ideally or excessively formal meaning unless clearly defined in the present invention.

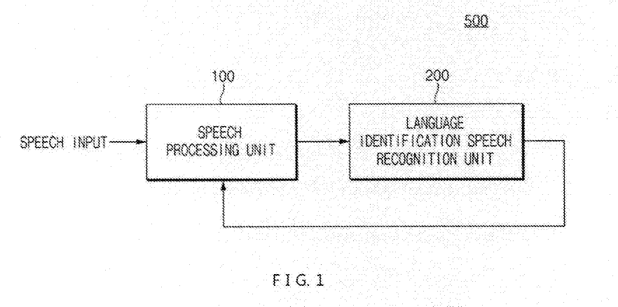

FIG. 1 is a conceptual view of a speech recognition system 500 according to an exemplary embodiment of the present invention, which simultaneously performs language identification and speeds recognition by using input speech.

Referring to FIG. 1, the speech recognition system 500 according to the exemplary embodiment of the present invention includes a speech processing unit 100 and a language identification and speech recognition unit 200.

The speech recognition system 500 according to the exemplary embodiment of the present invention is a device which may operate while being installed in a user terminal which is communicatable through a wired/wireless network that supports wired Internet communication or wireless internet communication such as WiFi, WiBro, and the like, mobile communication such as WCDMA, LTE, and the like or wireless communication such as wireless access in vehicular environment (WAVE), and the like. For example, the user terminal includes wired terminals such as a desktop PC, other communication dedicated terminals, and the like and besides, the user terminal may include wireless terminals such as a smart phone, a speech/video telephone call available wearable device, a tablet PC, a notebook PC, and the like according to a communication environment.

The speech processing unit 100 receives a speech signal transferred online through the networks or through a microphone of the user terminal to extract feature date through speech signal analysis such as frequency analysis, and the like. When the speech processing unit 100 receives a feedback for language information (e.g., a character string or a word string or information indicating of which country a corresponding language among multiple languages is a language) identified by the language identification and speech recognition unit 200, the speech processing unit 100 may perform a postprocessing procedure of outputting a speech recognition result in various forms. When the language is identified, the speech processing unit 100 may support the speech recognition result to be used for other applications through a predetermined output interface in the language identification speech recognition unit 200 according to information on the corresponding identified language information and display the result on the user terminal and the like through characters, and the like or provide a result acquired by translating the result into another language, and the like to the user terminal, and the like. When the language is identified, the speech processing unit 100 may stop extraction of the feature data in which the language is not distinguished and perform signal analysis for effectively extracting the feature data according to the corresponding language information.

The language identification speech recognition unit 200 receives the feature data for the speech signal from the speech processing unit 100 to simultaneously perform the language identification and the speech recognition and feed back the identified language information to the speech processing unit 100. The language identification speech recognition unit 200 may identify the language for the corresponding speech signal through analysis of likelihood (likelihood with an acoustic model and a language model) of the feature data by referring to a database storing and managing an acoustic model (a common phone of the multiple languages and a distinguishing phone of individual languages) and a database storing and managing a language model (syllable and word characters, and the like of the individual languages).

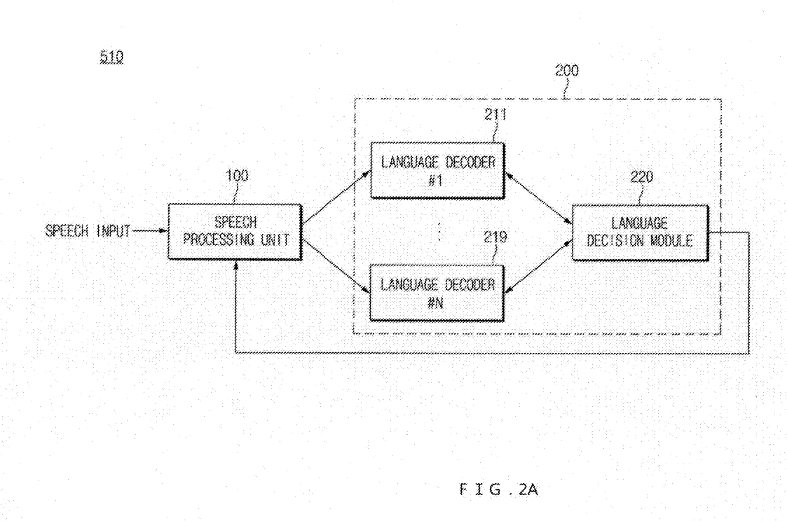

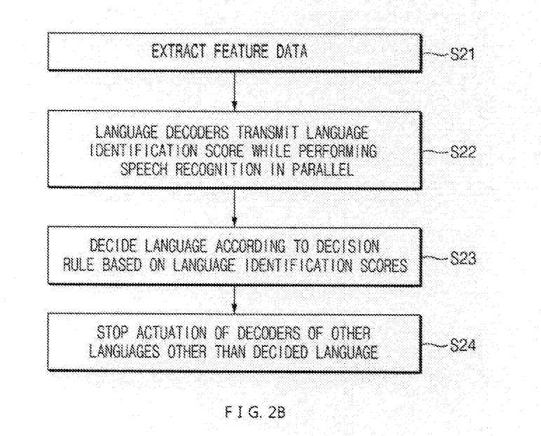

FIG. 2A illustrates a speech recognition system 510 having a first detailed example of a language identification speech recognition unit 200 of FIG. 1, which is used for simultaneously performing parallel speech recognition and language decision by sending the input speech to each language decoder.

Referring to FIG. 2A, the speech recognition system 510 according to the first detailed example includes the speech processing unit 100 illustrated in FIG. 1 and besides, the speech recognition system 510 is constituted by the language identification speech recognition unit 200 including a plurality of (e.g., a natural number N) language (network) decoders 211 to 219 and a language decision module 220.

In FIG. 2A, the speech recognition system 510 includes a configuration of extracting a feature of a speech transferred in the terminal or the network and simultaneously transmitting the extracted feature to the individual language decoders 211 to 219 every frame or with a bundle of multiple frames, a configuration of transmitting a language identification score to the language decision module 220 every frame or with the bundle of the multiple frames in the individual language decoders 211 to 219, a configuration comparing transmitted and accumulated language identification scores by using a decision rule of the language decision module 220 and sending a command to sequentially stop language decoders having a low score, and finally, a configuration of automatically simultaneously performing the language identification and the speech recognition by a method that shows the speech recognition result of the residual language decoder having a high score.

Hereinafter, an operation of the speech recognition system 510 of FIG. 2A will be described with reference to a flowchart of FIG. 2B.

The speech processing unit 100 receives the speech signal transferred online through the network or through the microphone of the user terminal to extract the feature data through the signal analysis such as the frequency analysis, and the like and simultaneously transfer the feature data to each of the language decoders 211 to 219 every frame or per multiple frames (S21). The speech processing unit 100 may store the feature data in a predetermined memory and manage each of the language decoders 211 to 219 to be allowed to access the feature data by sharing the memory.

The respective language decoders 211 to 219 are decoders for speech recognition of the individual languages (e/g., Korean, English, French, Japanese, and the like). The respective language decoders 211 to 219 performs the speech recognition for the feature data from the speech processing unit 100 in parallel and may calculate the language identification score through analysis of the likelihood every one or more speech signal frames based on the feature data by referring to the acoustic model and the language module of the corresponding language (S22). The respective language (network) decoders 211 to 219 may refer to (identify and search a local language) a local database in which the acoustic model and the language model are stored and managed and in some cases, a server on the wired/wireless network may refer to (identify and search the network language) a plurality of databases in which the acoustic model and the language model are stored and managed.

The language decision module 220 determines a language corresponding to a selected target language decoder as the identified language according to the decision rule (e.g., a method that selects the language decoder having the high score, and the like) by referring to the language identification score accumulated while being received from the respective language decoders 211 to 219 (S23). The language decision module 220 transmits the identified language information (e.g., the character string recognized by the decoder of the identified language, and the like) to the speech processing unit 100 and ends a decoding operation by transmuting a decoding end command to a language decoder(s) other than the target language decoder among the language decoders 211 to 219. For example, the language decision module 220 sequentially transmits the decoding end command to the language decoders having the low score based on the language identification scores accumulated while being received from the language decoders 211 to 219 to end the operation.

As a result, when the language decoder(s) other than the target language decoder among the language decoders 211 to 219 receive(s) the decoding end command, the language decoder(s) 211 to 219 immediately end(s) the speech recognition and the calculation and give(s) a response to the language decision module (S24). The target language decoder that does not receive the decoding end command outputs the recognized character string (alternatively, the word string) according to the result of performing the speech recognition. The speech processing unit 100 may finally output the result of the speech recognition in the residual target language decoder.

As described above, in the present invention, a multilingual parallel speech recognizer scheme is used to simultaneously perform the speech recognition and the language identification in the language identification speech recognition unit 200. In the above description, the language decision module 220 preferentially transfers the decoding end command to the language decoder having the low language identification score according to the decision rule. That is, the speech recognition and the language identification are simultaneously performed by a method that sequentially stops all of language decoders having a large likelihood from the vocalized language, which is calculated based on the decision rule.

As described above, the method of the present invention simultaneously operates various language decoders, but the decoders of the spoken language and the decoders of other languages rapidly stop by the decision rule of the language decision module 220, and as a result, the service may be provided by an online server scheme that houses multiple language decoders, which is performed shortly. Further, since the acoustic model and the language model learned for each language are used, it is advantageous in that a new model for the language identification needs not be generated.

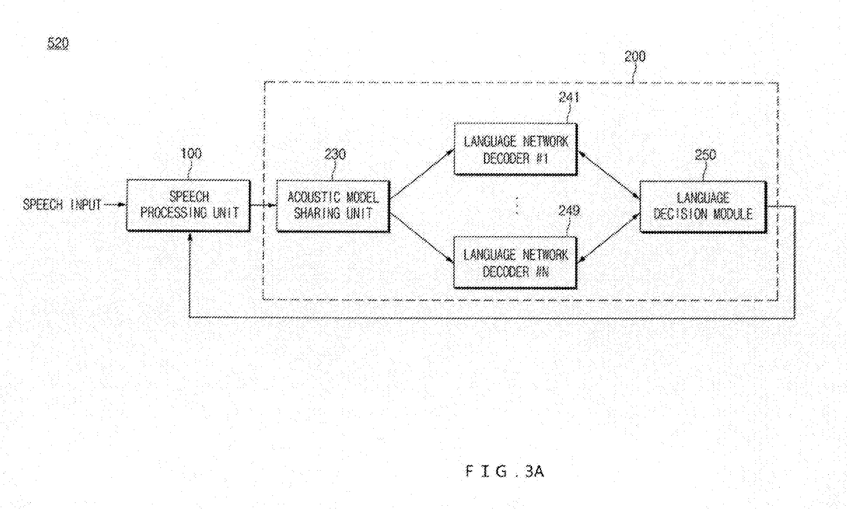

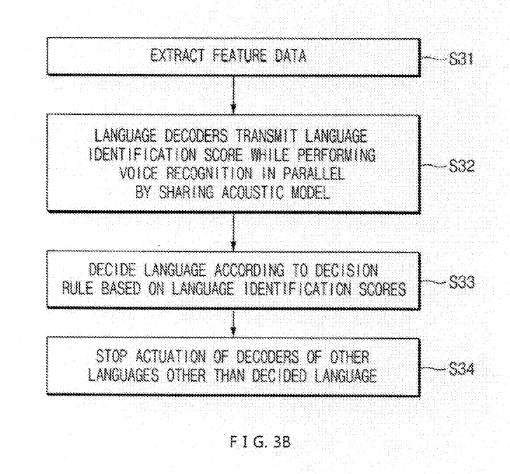

Meanwhile, the language identification scores calculated by the respective language decoders 211 to 219 as above may be calculated by several methods. It is, in advance, revealed that the language identification score may be calculated as described below even in language network decoders 241 to 249 in FIG. 3A.

First, the language identification score may be a value acquired by aggregating an acoustic model score which is a likelihood analysis result for the acoustic model and a language model score which is the likelihood analysts result for the language model. The language identification score is transmitted to the language decision module 220 every frame or every multiple frames to be compared with the score from another language decoder by using a basic characteristic in which a word string having closer likelihood to the vocalized language shows a higher score.

The language (network) decoders 211 to 219 generate a token which is language candidate information which may include data such as paths or addresses for similar language candidates at the time of identifying and searching the network language and in this case, the number of tokens may be used as the language identification score every frame or every multiple frames. That is, when matching likelihood with the corresponding acoustic model or language model is high, the number of tokens decreases while the number of candidate words decreases, but when there is no candidate which is accurately matched, similar candidates are found, and as a result, the number of tokens also increases while the number of candidates increases. Due to such a characteristic, in this method, the low score (a value in which an inverse number of the number of tokens is large) becomes an advantageous value.

When the language identification scores according to various methods or the language identification score according to a combination thereof are transmitted to the language decision module 220, the language decision module 220 performs the language identification according to the decision rule. The decision rule which may be primarily used is a method that accumulates aggregations of the acoustic model scores and the language model scores every frame and compares the aggregations with each other and sequentially ends decoders having a lower accumulated score value when the accumulation score is different from a highest accumulated score value by a threshold or more. On the contrary, in the case of the decision rule using the number of tokens as described above, a method that ends, when the number of tokens accumulated every frame is different from the predetermined smallest number of accumulated tokens by the threshold or more, a language decoder having the corresponding large number of tokens may be used as the decision rule.

The decision rule may be made by mixing the two score values described above with each other and the threshold is not set to a fixed value and may be changed into a linear function with time. That is, the language decoders having outputting the corresponding language identification score different from the highest accumulated language identification score per frame by the corresponding reference value or more by applying the threshold which varies with time may sequentially end. In addition, since the acoustic models and the language networks may be differently configured in the respective decoders 211 to 219/241 to 249 for different languages, it is difficult to equally compare the scores. Therefore, the speech recognition system 510 needs to be applied to the decision rule through appropriate score scaling between the decoders through a comparison experiment in advance.

FIG. 3A illustrates a speech recognition system 520 having a second detailed example of the language identification speech recognition unit of FIG. 1 for calculating language identification and speech recognition for input speech for each of an acoustic model sharing unit and a language network decoder.

Referring to FIG. 3A, the speech recognition system 520 according to the second detailed example includes the speech processing unit 100 illustrated in FIG. 1 and besides, the speech recognition system 520 is constituted by the language identification speech recognition unit 200 including the acoustic model sharing unit 230, a plurality of (e.g., the natural number N) language network decoders 241 to 249 and the language decision module 250.

In FIG. 3A, the speech recognition system 520 includes a configuration of extracting a feature of the speech transferred in the terminal or the network and transmitting the extracted feature to the acoustic model sharing unit 230, a configuration of calculating the score with the acoustic model which is partially shared or totally shared and simultaneously transmitting the value to the language network decoders 241 to 249 of the individual languages every frame or with the bundle of the multiple frames, a configuration of transmitting the language identification score to the language decision module 250 every frame or with the bundle of the multiple frames in the language network decoders 241 to 249 of the individual languages, a configuration of comparing transmitted and accumulated scores for each language identification by using the decision rule of the language decision module 250 and sending a command to sequentially stop language network decoders having a low score, and finally, a configuration of automatically simultaneously performing the language identification and the speech recognition by a method that shows the speech recognition result of the residual language network decoder having a high score.

Hereinafter, an operation of the speech recognition system 520 of FIG. 3A will be described with reference to a flowchart of FIG. 3B.

The speech processing unit 100 receives the speech signal transferred online through the network or through the microphone of the user terminal to extract the feature data through the signal analysis such as the frequency analysis, and the like and transfers the feature data to the acoustic model sharing unit 230 every frame or per multiple frames (S31). The speech processing unit 100 may store the feature data in a predetermined memory and manage the acoustic model sharing unit 230 to be allowed to access the memory.

The acoustic model sharing unit 230 calculates the acoustic model score through the analysis of the likelihood every one or more speech signal frames based on the feature data by referring to the acoustic model for the multiple languages, and the like by receiving the feature data from the speech processing unit 100 and outputs and shares the acoustic model score to the language network decoders 241 to 249 (S32).

General speech recognition is a process that finds an optimal word path while calculating the acoustic model score and the language model score on a word unit language network by extracting the feature data for the input speech signal. Herein, as yet another method for identifying the language while performing the speech recognition as illustrated in FIG. 3A, a method is used, which reduces cost for calculating the acoustic model score of each language by sharing the acoustic model sharing unit 230 in the language network decoders 241 to 249 and transmits the language identification score to the language decision module 250 while searching the language networks of the respective languages in parallel. In the case of this method as a method that reduces calculation of the acoustic model score in which the largest calculation cost is generated during speech recognition, in a speech recognizer using a deep neural network (DNN) acoustic model (AM) which has been frequently used in recent years, a portion occupied by the acoustic model score calculation among total calculation may reach 80%. The acoustic model sharing unit 230 of FIG. 3A transfers the calculated acoustic model score to the language network decoders 241 to 249 every frame or throughout the multiple frames to search the language networks in parallel.

Herein, the acoustic model sharing method may be generally divided into two methods. First, a method that shares a partial structure of the acoustic model for each language of multiple languages may be used and second, a method that shares all acoustic models of predetermined multiple languages by generating the acoustic model by using a multilingual common phone may be used. First, in a method that calculates the acoustic model score by sharing a partial structure of the acoustic model for each language of the multiple languages, a total structure of the DNN acoustic model may be divided into an input layer, a hidden layer, and an output layer and a method is used, which learns the acoustic model by sharing the total layer other than the output layer among or sharing only the hidden layer. As a result, an advantage in which the acoustic model structure (the input layer or the hidden layer) is shared while maintaining nodes of the output layer having unique phone characteristics of the individual languages may be acquired. In addition, in a method that generates the acoustic model by using the multilingual common phone and calculates the acoustic model score by sharing all acoustic models of the predetermined multiple languages, a method is used, which learns all multilingual acoustic models together by defining all of the phone commonly shared by referring to the multilingual common phone and individual phones which are not commonly shared. As a result, in the second method, the number of nodes of the DNN acoustic model output layer relatively increases with respect to one language as compared with the first method, but all acoustic models may be shared.

The acoustic model score calculated by the acoustic model sharing unit 230 is simultaneously transmitted to the language network decoders 241 to 249 of the respective languages every frame or with the bundle of the multiple frames and the respective language network decoders 241 to 249 combine the shared acoustic model score and the language model score together to search the language network and perform the speech recognition. The respective language network decoders 241 to 249 are decoders for speech recognition of the individual languages (e/g., Korean, English, French, Japanese, and the like). The respective language network decoders 241 to 249 generate the language identification score acquired by aggregating the acoustic model score shared from the acoustic model sharing unit 230 and the language model score calculated in parallel by referring to the language model in parallel to receive an approval of searching the network by transferring the generated language identification score to the language decision module 250 (S32). The respective language network decoders 241 to 249 may calculate the language model score through the analysis of the likelihood every one or more speech signal frames based on the feature data by referring to the language model, and the like.

The acoustic model sharing unit 230 and the language network decoders 241 to 249 may refer to (identify and search a local language) a local database in which the acoustic model and the language model are stored and managed and in some cases, a server on the wired/wireless network may refer to (identify and search the network language) a plurality of databases in which the acoustic model or the language model are stored and managed.

The language decision module 250 determines a language corresponding to a selected target language decoder as the identified language according to the determination rule (e.g., a method that selects the language decoder having the high score, and the like) by referring to the language identification score accumulated from the respective language decoders 211 to 219 (S33). The language decision module 250 transmits the identified language information (e.g., the character string recognized by the decoder of the identified language, and the like) to the speech processing unit 100 and sequentially transmits a decoding end command to a language decoders) other than the target language decoder among the language network decoders 241 to 249. That is, the language decision module 250 sequentially transmits the decoding end command to the language network decoders having the low score based on the accumulated language identification scores to end the operation.

As a result, when the language decoder(s) other than the target language decoder among the language network decoders 241 to 249 receive(s) the decoding end command, the language decoder(s) immediately end(s) the speech recognition and the calculation and give(s) a response to the language decision module 250 (S44). The target language decoder that does not receive the decoding end command outputs the recognized character string (alternatively, the word string) according to the result of performing the speech recognition. The speech processing unit 100 finally outputs the result of the speech recognition in the residual target language decoder.

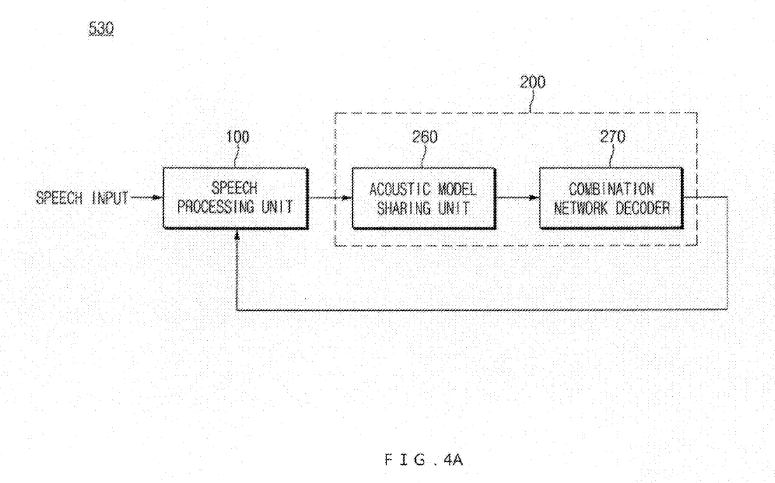

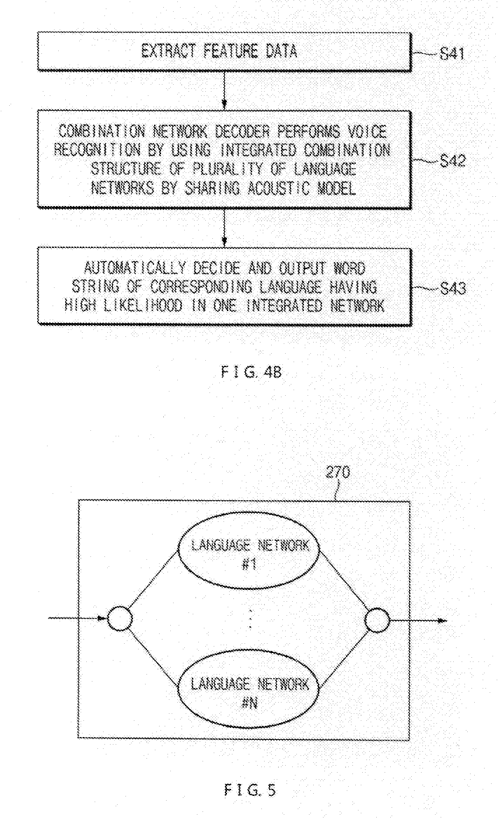

FIG. 4A illustrates is a speech recognition system 530 having a third detailed example of the language identification speech recognition unit of FIG. 1 for calculating language identification and speech recognition for input speech separately in each of an acoustic model sharing unit and a combination network unit.

Referring to FIG. 4A, the speech recognition system 530 according to the third detailed example includes the speech processing unit 100 illustrated in FIG. 1 and besides, the speech recognition system 530 is constituted by the language identification speech recognition unit 200 including the acoustic model sharing unit 260 and a combination network decoder 270.

In FIG. 4A, the speech recognition system 530 includes a configuration of extracting the feature of the speech transferred in the terminal or the network and transmitting the extracted feature to the acoustic model sharing unit 260, a configuration of calculating the score with a total shared acoustic model by using the common phone in the acoustic model sharing unit 260 and transmitting the value to the combination network decoder 270 every frame or with the bundle of the multiple frames, and a configuration of automatically simultaneously performing the language identification and the speech recognition by a method that searches one network acquired by combining the language networks of the individual languages to show the speech recognition result in the combination network decoder 270.

Hereinafter, an operation of the speech recognition system 530 of FIG. 4A will be described with reference to a flowchart of FIG. 4B.

The speech processing unit 100 receives the speech signal transferred online through the network or through the microphone of the user terminal to extract the feature data through the signal analysis such as the frequency analysis, and the like and transfer the feature data to the acoustic model sharing unit 260 every frame or per multiple frames (S41). The speech processing unit 100 may store the feature data in a predetermined memory and manage the acoustic model sharing unit 230 to be allowed to access the memory.

The acoustic model sharing unit 260 calculates the acoustic model score through the analysis of the likelihood every one or more speech signal frames based on the feature data by referring to the acoustic model for the multiple languages, and the like by receiving the feature data from the speech processing unit 100 and outputs and shares the acoustic model score to the combination network decoder 270 (S42). Similarly to the acoustic model sharing unit 230 of FIG. 3A, the acoustic model sharing unit 260 may use a method that generates the acoustic model by using the multilingual common terminal among the user terminals such as the smart phone, and the like to share all acoustic models (the acoustic model totally shared by using the common phone of the multiple languages) of predetermined multiple languages in order to calculate the acoustic model score.

The combination network decoder 270 has the acoustic model score transferred every one or more speech signal frames in the acoustic model sharing unit 260 and performs the speech recognition by performing a network decoding calculation for the feature data based on one integration network acquired by coupling the networks of the respective languages (S42).

That is, the combination network decoder 270 outputs a character string (alternatively, word string) decided as the highest score based on the language identification score acquired by aggregating the acoustic model score shared from the acoustic model sharing unit 230 and the language model score calculated by referring to the language models for the multiple languages (e/g., Korean, English, French, Japanese, and the like) (S43). The combination network decoder 270 may calculate the language model score through the analysis of the likelihood every one or more speech signal frames based on the feature data by referring to the multilingual language model, and the like.

FIG. 4A illustrates a method that uses one acoustic model and the one integrated language network in order to simultaneously perform the language identification and the speech recognition. For this method, the acoustic model sharing unit 230 calculates the acoustic model score by using the multilingual common phone and the individual language distinguishing phones together. Then, the combination network decoder 270 may calculate the language model score and the language identification score while referring to the integrated language model database, and the like by combining the phones generated while calculating the acoustic model score on the DNN acoustic model by the acoustic model sharing unit 230 on the integrated language network (see the language model databases of the respective languages or see one integrated language model database for the multiple languages) in which the language networks of the individual languages are combined into one and the languages are not distinguished. The combination network decoder 270 may be configured to generate the character string (alternatively, word string) decided as the highest language identification score acquired by aggregating the acoustic model score and the language model score to search the multiple languages in one integrated network.

The combination network decoder 270 has a decoding network structure in which the language networks of the plurality of (e.g., the natural number N) individual languages are integrated into one as illustrated in FIG. 5. In this case, the combination network decoder 270 may be a simple combination scheme connecting only a first language network and a last language network of the language networks of the plurality of individual languages, that is, a type (the individual calculations are performed in the respective networks) in which the language networks of the individual languages are just collected and combined by considering efficiency and a capability of a network configuration, but preferably a strong combination scheme in which the language networks of the plurality of individual languages are reconfigured, that is, an integrated network type (one calculation is performed in one network) in which a proper noun and frequently used foreign words have a close combination relationship while being connected with each other through the reconfiguration step.

An advantage of using one shared acoustic model and one integrated language network as described above is in that calculation cost may be saved by using one acoustic model sharing unit 230 as illustrated in FIG. 3A and in that the language is automatically decided by word strings having the high likelihood through searching one integrated language network without the need of a separate language decision module 220/250 as illustrated in FIG. 2A/3A. Since the networks of the multiple languages are combined, a lot of memories are consumed, but when the network search is configured by parallel processes, the search may be effectively performed.

When the speech processing unit 100 receives a feedback of the language information identified by the combination network decoder 270, that is, the character string (alternatively, word string) decided as the highest score, the speech processing unit 100 may perform a postprocessing part that shows the corresponding recognized result. Further, the speech processing unit 100 may stop extraction of the feature data in which the language is not distinguished and perform signal analysis for effectively extracting the feature data according to the corresponding language information.

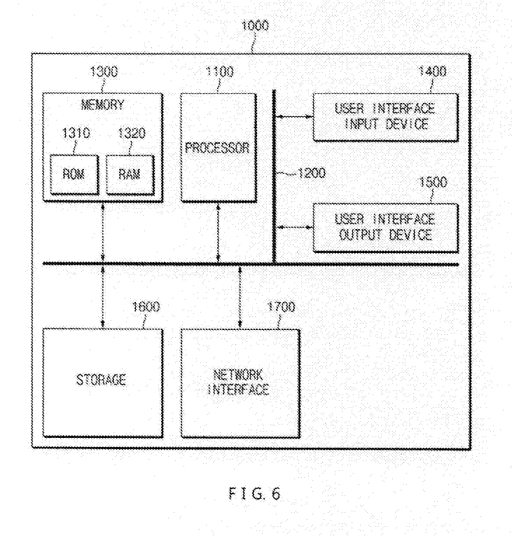

FIG. 6 is a diagram for describing an example of an implementation method of a speech recognition system 500 according to an exemplary embodiment of the present invention. The speech recognition system 500 according to the exemplary embodiment of the present invention may be achieved by hardware, software, or a combination thereof. For example, the speech recognition system 500 may be implemented as a computing system 1000 illustrated in FIG. 6.

The computing system 1000 may include at least one processor 1100, a memory 1300, a user interface input device 1400, a user interface output device 1500, a storage 1600, and a network interface 1700 connected through a bus 1200. The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Therefore, steps of a method or an algorithm described in association with the embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

As described above, in the speech recognition system 500 according to the present invention, a speech language can be automatically identified during speech recognition of a person who vocalizes to effectively process multilingual speech recognition without a separate process for user registration or recognized language setting such as use of a button for selecting a language to be manually vocalized to the user. In the existing method, the language is decided by a method that records a used language in registration contents of the user in the terminal of the user in advance, but since language identification starts while the speech is transferred, the present invention is not dependent on the user terminal without the need of an advance work. Further, in the speech recognition system 500 according to the present invention, convenience of the user may be increased by supporting automatic multilingual speech recognition so as to automatically perform speech recognition of each language even though persons of different languages vocalize by using one terminal. The present invention may be applied so as to record contents of a conference of persons having a plurality of different languages, such as a multilingual conference. In addition, in the speech recognition system 500 according to the present invention, since the language is discriminated based on the score measured while performing the speech recognition with respect to the speech which is vocalized in real time, the speech recognition result may be rapidly received without performing the language identification dedicated recognizer in advance.

The above description just illustrates the technical spirit of the present invention and various modifications and transformations can be made to those skilled in the art without departing from an essential characteristic of the present invention.

Therefore, the exemplary embodiments disclosed in the present invention are used to not limit it but describe the technical spirit of the present invention and the scope of the technical spirit of the present invention is not limited by the embodiments. The scope of the present invention should be interpreted by the appended claims and it should be analyzed that all technical spirit in the equivalent range are intended to be embraced by the scope of the present invention.

What is claimed is:

1. A system of speech recognition comprising:
a speech processing unit analyzing a speech signal to extract feature data; and
a language identification speech recognition unit performing language identification and speech recognition by using the feature data and feeding back identified language information to the speech processing unit,
wherein the speech processing unit outputs a result of the speech recognition in the language identification speech recognition unit according to the fed-back identified language information.

2. The system of claim 1, wherein the language identification speech recognition unit identifies a language for the speech signal through analysis of likelihood with respect to the feature data by referring to an acoustic model and a language model.

3. The system of claim 1, wherein the language identification speech recognition unit includes
a plurality of language decoders each performing the speech recognition for the feature data in parallel and calculating a language identification score through the analysis of the likelihood every one or more speech signal frames based on the feature data by referring to the acoustic model and the language model of a corresponding language, and
a language decision module deciding as the identified language a language corresponding to a selected target language decoder according to a decision rule by referring to the language identification scores accumulated while being received item the plurality of language decoders to output the identified language information.

4. The system of claim 3, wherein the language decision module sequentially transmits a decoding end command to language decoders having a low score based on the accumulated language identification scores to end operations of the language decoders, and as a result, the speech processing unit outputs the result of the speech recognition in the target language decoder which finally remains.

5. The system of claim 3, wherein the language identification score is configured by a value acquired by aggregating an acoustic model score and a language model score or an inverse number to the number of tokens for similar language candidates which are generated while searching a network, or a combination thereof.

6. The system of claim 3, wherein the decision rule includes a scheme that sequentially ends language decoder which output a corresponding language identification score different from the highest accumulated language identification score value by a threshold or more per frame or a scheme that sequentially ends the language decoders which output the corresponding language identification scores different from the highest accumulated language identification score value by the corresponding threshold or more per frame by applying the threshold which varies with time.

7. The system of claim 1, wherein the language identification speech recognition unit includes
an acoustic model sharing unit calculating the acoustic model score through the analysis of the likelihood every one or more speech signal frames based on the feature data by sharing some of the acoustic models of the respective language among the multiple languages or all acoustic models of predetermined multiple languages,
a plurality of language network decoders each performing the speech recognition of the feature data by sharing the acoustic model scores in parallel and calculating the language identification score acquired by aggregating the shared acoustic model scores and the language model scores calculated based on the feature data by referring to the language model, and
a language decision module deciding as the identified language a language corresponding to a selected target language decoder according to a decision rule by referring to the language identification scores accumulated while being received from the plurality of language network decoders to output the identified language information.

8. The system of claim 7, wherein the language decision module sequentially transmits a decoding end command to language network decoders having a low score based on the accumulated language identification scores to end operations of the language network decoders, and as a result, the speech processing unit outputs the result of the speech recognition in the target language decoder which finally remains.

9. The system of claim 1, wherein the language identification speech recognition unit includes
an acoustic model sharing unit calculating the acoustic model score through the analysis of the likelihood every one or more speech signal frames based on the feature data by sharing all of the acoustic models of the predetermined multiple languages and using the multilingual common phones and phones of individual languages together, and
a combination network decoder performing the speech recognition of the feature data by using an integrated language network in which the language is not distinguished by integrating the language networks of the plurality of individual languages into one, calculating the language identification score acquired by aggregating the shared acoustic model score and the language model score calculated based on the feature data by referring to the language model, and outputting a character string decided as a highest score based on the language identification score.

10. The system of claim 9, wherein the speech processing unit outputs the decided character string which is a result of the speech recognition in the combination network decoder through a predetermined output interface.

11. A method of speech recognition, the method comprising:
analyzing a speech signal to extract feature data;
performing language identification and speech recognition by using the feature data and outputting identified language information; and
outputting a result of the speech recognition through the predetermined output interface according to identified language information.

12. The method of claim 11, wherein in the outputting of the identified language information, a language for the speech signal is identified through analysis of likelihood with respect to the feature data by referring to an acoustic model and a language model.

13. The method of claim 11, wherein the outputting of the identified language information includes
performing, by each of a plurality of language decoders, the speech recognition for the feature datain parallel and calculating a language identification score through the analysis of the likelihood every one or more speech signal frames based on the feature data by referring to the acoustic model and the language model of a corresponding language, and
deciding, by a language decision module, as the identified language a language corresponding to a selected target language decoder according to a decision rule by referring to the language identification scores accumulated while being received from the plurality of language decoders to output the identified language information.

14. The method of claim 13, wherein in the outputting of the identified language information,
a decoding end command is sequentially transmitted to language decoders having a low score based on the accumulated language identification scores to end operations of the language decoders, and as a result, the result of the speech recognition is output in the target language decoder which finally remains.

15. The method of claim 13, wherein the language identification score is configured by a value acquired by aggregating an acoustic model score and a language model score or an inverse number to the number of tokens for similar language candidates which are generated while searching a network, or a combination thereof.

16. The method of claim 13, wherein the decision rule includes a scheme that sequentially ends language decoders which output corresponding language identification score different from the highest accumulated language identification score by a threshold or more per frame or a scheme that sequentially ends the language decoders which output the corresponding language identification scores different from the highest accumulated language identification score value by the corresponding threshold or more per frame by applying the threshold which varies with time.

17. The method of claim 11, wherein the outputting of the identified language information includes
calculating the acoustic model score through the analysis of the likelihood every one or more speech signal frames based on the feature data by sharing some of the acoustic models of the respective language among the multiple languages or all acoustic models of predetermined multiple languages,
performing, by each of a plurality of language network decoders, the speech recognition of the feature data by sharing the acoustic model scores in parallel and calculating the language identification score acquired by aggregating the shared acoustic model scores and the language model scores calculated based on the feature data by referring to the language model, and
deciding as the identified language a language corresponding to a selected target language decoder according to a decision rule by referring to the language identification scores accumulated while being received from the plurality of language network decoders to output the identified language information.

18. The method of claim 17, wherein in the outputting of the identified language information, a decoding end command is sequentially transmitted to language network decoders having a low score based on the accumulated language identification scores to end operations of the language network decoders, and as a result, the result of the speech recognition is output in the target language decoder which finally remains.

19. The method of claim 11, wherein the outputting of the identified language information includes
calculating the acoustic model score through the analysis of the likelihood every one or more speech signal frames based on the feature data by sharing all of the acoustic models of the predetermined multiple languages and using the multilingual common phones and distinguishing phones of individual languages together, and
performing, by a combination network decoder integrating language networks of the plurality of individual languages into one, the speech recognition of the feature data by using an integrated language network in which the language is not distinguished, calculating the language identification score acquired by aggregating the shared acoustic model score and the language model score calculated based on the feature data by referring to the language model, and outputting a character string decided as a highest score based on the language identification score.

20. The method of claim 19, further comprising:
outputting the decided character string which is a result of the speech recognition in the combination network decoder through a predetermined output interface.
